(19) United States
(12) Patent Application Publication
(10) Pub. No.: US 2026/0046592 A1
(43) Pub. Date: Feb. 12, 2026

(54) APPARATUS, METHODS, AND COMPUTER PROGRAMS

(71) Applicant: Nokia Technologies Oy, Espoo (FI)

(72) Inventors: Saurabh KHARE, Bangalore (IN); Bruno LANDAIS, Lannion (FR)

(21) Appl. No.: 19/100,671

(22) PCT Filed: Aug. 5, 2023
(86) PCT No.: PCT/IB2023/057933

§ 371 Date: Feb. 3, 2025

(30) Foreign Application Priority Data
Aug. 5, 2022 (GB) 2211446.6

(51) Int. Cl. H04W 4/50; H04L 67/55

(52) U.S. Cl. CPC H04W 4/50; H04L 67/55

(57) ABSTRACT

An apparatus comprises at least one processor and at least one memory storing instructions for a network function. The instructions when executed by the at least one processor cause the apparatus to perform: receiving subscription information defining a scope for a subscription, the subscription being for a network function service consumer to receive events from a network function service producer, the events being associated with a communications device; and determining, based on the subscription information, that the subscription to the network function service producer is to be set up.

### CROSS-REFERENCE TO RELATED APPLICATIONS

This patent application claims the benefit of priority of United Kingdom Patent Application No. 2211446.6, filed Aug. 5, 2022, the contents of which are hereby incorporated by reference.

### FIELD OF THE DISCLOSURE

The present disclosure relates to apparatus, methods, and computer programs and in particular but not exclusively to apparatus, methods and computer programs for network functions.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of a standard are the so-called 5G standards.

### SUMMARY

According to a first aspect, there is provided an apparatus comprising: means for receiving at a network function producer, a subscription and subscription information defining a scope for the subscription, the subscription being for a network function consumer to receive events from the network function producer, the events being associated with a communications device; and means for causing events to be notified by the network function producer to the network function consumer.

The apparatus may comprise means for determining if the events are to be provided to the network function consumer based on the subscription information defining the scope of the subscription.

The determining if the events are to be provided to the network function consumer may be based on if the subscription scope is matched by the network function producer for the communication device.

The apparatus may comprise means for determining if the events are still to be provided to the network function consumer based on the subscription information defining the scope of the subscription, when there is a change associated with the communications device.

The change associated with the communications device comprises one or more of: a change in location of the communications device; a change of public land mobile network; a network slice change; and/or a change of standalone non-public network.

The apparatus may comprise means for causing a message to be sent to the network function consumer indicating that the subscription has ended when it is determined based on the subscription information defining the scope of the subscription that the events are not be provided any longer to the network function consumer when there is a change associated with the communications device which results in the scope of the subscription being no longer matched.

The apparatus may comprise means for determining if the events are to be provided to the network function consumer based on the subscription information defining the scope of the subscription, when there is a change associated with the communications device.

The apparatus may comprise means for causing a message to be sent to the network function consumer indicating that the subscription has ended, when it is determined based on the subscription information defining the scope of the subscription that the events are not be provided to the network function consumer when there is a change associated with the communications device.

The apparatus may comprise means for determining if the subscription of the network function consumer is to be transferred to a target network function producer, wherein the determining is based on the subscription information defining the scope of the subscription.

The determining if the subscription of the network function consumer is to be transferred to a target network function producer may be based on a public land mobile network identity, and/or a standalone non-public network, and/or region and/or area of the target network function.

The determining if the subscription of the network function consumer is to be transferred to a target network function producer may be based on the public land mobile network identity, and/or a standalone non-public network, and/or region and/or area of the target network function producer falls within the scope of the subscription.

The determining if the subscription of the network function consumer is to be transferred to a target network function producer may be performed in response to the communication device moving from the network function producer to the target network function producer.

The apparatus may comprise means for causing a message to be sent to the network function consumer indicating that the subscription has ended, when it is determined that the subscription is not to be transferred to the target network function producer.

The apparatus may comprise means for causing the subscription to be transferred to the target network function producer, when it is determined that the subscription is to be transferred to the target network function producer, and for causing the subscription information defining the scope of the subscription to be provided to the target network function producer.

The apparatus may comprise means for determining, in response to receiving the subscription and subscription information defining the scope for the subscription, if events are to be provided to the network function consumer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more standalone non-public network in which the subscribing to events applies; one or more standalone non-public network in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The apparatus may be provided in a network function producer or be a network function producer.

According to a second aspect, there is provided apparatus comprising: means for receiving at a network function producer, a subscription and subscription information defining a scope for the subscription, the subscription being for a network function consumer to receive events from the network function producer, the events being associated with a communications device; and means for, based on said subscription information, determining if events are to be provided to the network function consumer.

The apparatus may be provided in a network function producer or be a network function producer.

It should be appreciated that one or more of the features of the first described aspect may be used in combination with this second aspect.

According to a third aspect, there is provided an apparatus comprising: receiving circuitry configured to receive at a network function producer, a subscription and subscription information defining a scope for the subscription, the subscription being for a network function consumer to receive events from the network function producer, the events being associated with a communications device; and circuitry configured to cause events to be notified by the network function producer to the network function consumer.

The apparatus may comprise circuitry configured to determine if the events are to be provided to the network function consumer based on the subscription information defining the scope of the subscription.

The determining if the events are to be provided to the network function consumer may be based on if the subscription scope is matched by the network function producer for the communication device.

The apparatus may comprise circuitry configured to determine if the events are still to be provided to the network function consumer based on the subscription information defining the scope of the subscription, when there is a change associated with the communications device.

The change associated with the communications device comprises one or more of: a change in location of the communications device; a change of public land mobile network; a network slice change; and/or a change of standalone non-public network.

The apparatus may comprise circuitry configured to cause a message to be sent to the network function consumer indicating that the subscription has ended when it is determined based on the subscription information defining the scope of the subscription that the events are not be provided any longer to the network function consumer when there is a change associated with the communications device which results in the scope of the subscription being no longer matched.

The apparatus may comprise circuitry configured to determine if the events are to be provided to the network function consumer based on the subscription information defining the scope of the subscription, when there is a change associated with the communications device.

The apparatus may comprise circuitry configured to cause a message to be sent to the network function consumer indicating that the subscription has ended, when it is determined based on the subscription information defining the scope of the subscription that the events are not be provided to the network function consumer when there is a change associated with the communications device.

The apparatus may comprise circuitry configured to determine if the subscription of the network function consumer is to be transferred to a target network function producer, wherein the determining is based on the subscription information defining the scope of the subscription.

The determining if the subscription of the network function consumer is to be transferred to a target network function producer may be based on a public land mobile network identity, and/or a standalone non-public network and/or region and/or area of the target network function.

The determining if the subscription of the network function consumer is to be transferred to a target network function producer may be based on the public land mobile network identity and/or a standalone non-public network and/or region and/or area of the target network function producer falls within the scope of the subscription.

The determining if the subscription of the network function consumer is to be transferred to a target network function producer may be performed in response to the communication device moving from the network function producer to the target network function producer.

The apparatus may comprise circuitry configured to cause a message to be sent to the network function consumer indicating that the subscription has ended, when it is determined that the subscription is not to be transferred to the target network function producer.

The apparatus may comprise circuitry configured to cause the subscription to be transferred to the target network function producer, when it is determined that the subscription is to be transferred to the target network function producer, and to cause the subscription information defining the scope of the subscription to be provided to the target network function producer.

The apparatus may comprise circuitry configured to determine, in response to receiving the subscription and subscription information defining the scope for the subscription, if events are to be provided to the network function consumer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more standalone non-public networks in which the subscribing to events applies; one or more standalone non-public networks in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The apparatus may be provided in a network function producer or be a network function producer.

According to a fourth aspect, there is provided apparatus comprising: circuitry configured to receive at a network function producer, a subscription and subscription information defining a scope for the subscription, the subscription being for a network function consumer to receive events from the network function producer, the events being associated with a communications device; and circuitry configured to, based on said subscription information, determine if events are to be provided to the network function consumer.

The apparatus may be provided in a network function producer or be a network function producer.

It should be appreciated that one or more of the features of the third aspect may be used in combination with this fourth aspect.

According to a fifth aspect there is provided an apparatus comprising at least one processor and at least one memory storing instructions that, when executed by the at least one processor cause the apparatus at least to: receive at a network function producer, a subscription and subscription information defining a scope for the subscription, the subscription being for a network function consumer to receive events from the network function producer, the events being associated with a communications device; and cause events to be notified by the network function producer to the network function consumer.

The apparatus may be caused to determine if the events are to be provided to the network function consumer based on the subscription information defining the scope of the subscription.

The determining if the events are to be provided to the network function consumer may be based on if the subscription scope is matched by the network function producer for the communication device.

The apparatus may be caused to determine if the events are still to be provided to the network function consumer based on the subscription information defining the scope of the subscription, when there is a change associated with the communications device.

The change associated with the communications device comprises one or more of: a change in location of the communications device; a change of public land mobile network; a network slice change; and/or a change of standalone non-public network.

The apparatus may be caused to cause a message to be sent to the network function consumer indicating that the subscription has ended when it is determined based on the subscription information defining the scope of the subscription that the events are not be provided any longer to the network function consumer when there is a change associated with the communications device which results in the scope of the subscription being no longer matched.

The apparatus may be caused to determine if the events are to be provided to the network function consumer based on the subscription information defining the scope of the subscription, when there is a change associated with the communications device.

The apparatus may be caused to cause a message to be sent to the network function consumer indicating that the subscription has ended, when it is determined based on the subscription information defining the scope of the subscription that the events are not be provided to the network function consumer when there is a change associated with the communications device.

The apparatus may be caused to determine if the subscription of the network function consumer is to be transferred to a target network function producer, wherein the determining is based on the subscription information defining the scope of the subscription.

The determining if the subscription of the network function consumer is to be transferred to a target network function producer may be based on a public land mobile network identity, and/or a standalone non-public network and/or region and/or area of the target network function.

The determining if the subscription of the network function consumer is to be transferred to a target network function producer may be based on the public land mobile network identity and/or a standalone non-public network and/or region and/or area of the target network function producer falls within the scope of the subscription.

The determining if the subscription of the network function consumer is to be transferred to a target network function producer may be performed in response to the communication device moving from the network function producer to the target network function producer.

The apparatus may be caused to cause a message to be sent to the network function consumer indicating that the subscription has ended, when it is determined that the subscription is not to be transferred to the target network function producer.

The apparatus may be caused to cause the subscription to be transferred to the target network function producer, when it is determined that the subscription is to be transferred to the target network function producer, and to cause the subscription information defining the scope of the subscription to be provided to the target network function producer.

The apparatus may be caused to determine, in response to receiving the subscription and subscription information defining the scope for the subscription, if events are to be provided to the network function consumer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more standalone non-public network in which the subscribing to events applies; one or more standalone non-public network in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The apparatus may be provided in a network function producer or be a network function producer.

According to a sixth aspect there is provided an apparatus comprising at least one processor and at least one memory storing instructions that, when executed by the at least one processor cause the apparatus at least to: receive at a network function producer, a subscription and subscription information defining a scope for the subscription, the subscription being for a network function consumer to receive events from the network function producer, the events being associated with a communications device; and based on said subscription information, determine if events are to be provided to the network function consumer.

The apparatus may be provided in a network function producer or be a network function producer.

It should be appreciated that one or more of the features of the fifth described aspect may be used in combination with this sixth aspect.

According to a seventh aspect, there is provided a method comprising: receiving at a network function producer, a subscription and subscription information defining a scope for the subscription, the subscription being for a network function consumer to receive events from the network function producer, the events being associated with a communications device; and causing events to be notified by network function producer to the network function consumer.

The method may comprise determining if the events are to be provided to the network function consumer based on the subscription information defining the scope of the subscription.

The determining if the events are to be provided to the network function consumer may be based on if the subscription scope is matched by the network function producer for the communication device.

The method may comprise determining if the events are still to be provided to the network function consumer based on the subscription information defining the scope of the subscription, when there is a change associated with the communications device.

The change associated with the communications device comprises one or more of: a change in location of the communications device; a change of public land mobile network; a network slice change; and/or a change of standalone non-public network.

The method may comprise causing a message to be sent to the network function consumer indicating that the subscription has ended when it is determined based on the subscription information defining the scope of the subscription that the events are not be provided any longer to the network function consumer when there is a change associated with the communications device which results in the scope of the subscription being no longer matched.

The method may comprise determining if the events are to be provided to the network function consumer based on the subscription information defining the scope of the subscription, when there is a change associated with the communications device.

The method may comprise causing a message to be sent to the network function consumer indicating that the subscription has ended, when it is determined based on the subscription information defining the scope of the subscription that the events are not be provided to the network function consumer when there is a change associated with the communications device.

The method may comprise determining if the subscription of the network function consumer is to be transferred to a target network function producer, wherein the determining is based on the subscription information defining the scope of the subscription.

The determining if the subscription of the network function consumer is to be transferred to a target network function producer may be based on a public land mobile network identity, and/or a standalone non-public network and/or region and/or area of the target network function.

The determining if the subscription of the network function consumer is to be transferred to a target network function producer may be based on the public land mobile network identity and/or region and/or area of the target network function producer falls within the scope of the subscription.

The determining if the subscription of the network function consumer is to be transferred to a target network function producer may be performed in response to the communication device moving from the network function producer to the target network function producer.

The method may comprise causing a message to be sent to the network function consumer indicating that the subscription has ended, when it is determined that the subscription is not to be transferred to the target network function producer.

The method may comprise causing the subscription to be transferred to the target network function producer, when it is determined that the subscription is to be transferred to the target network function producer, and for causing the subscription information defining the scope of the subscription to be provided to the target network function producer.

The method may comprise determining, in response to receiving the subscription and subscription information defining the scope for the subscription, if events are to be provided to the network function consumer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more standalone non-public network in which the subscribing to events applies; one or more standalone non-public network in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The method may be performed by an apparatus. The apparatus may be provided in a network function producer or be a network function producer.

According to an eighth aspect, there is provided a method comprising: receiving at a network function producer, a subscription and subscription information defining a scope for the subscription, the subscription being for a network function consumer to receive events from the network function producer, the events being associated with a communications device; and based on said subscription information, determining if events are to be provided to the network function consumer.

The method may be performed by an apparatus. The apparatus may be provided in a network function producer or be a network function producer.

It should be appreciated that one or more of the features of the seventh aspect may be used in combination with this eighth aspect.

According to a ninth aspect, there is provided an apparatus comprising: receiving means for receiving at a network function, a subscription and subscription information defining a scope for the subscription, the subscription being for a network function consumer to receive events from a network function producer, the events being associated with a communications device; and determining means for determining, based on the subscription information, that the subscription to the network function producer is to be set up.

The apparatus may comprise means for determining if the events are to be provided to the network function consumer based on the subscription information defining the scope of the subscription.

The determining if the events are to be provided to the network function consumer may be based on if the subscription scope is matched by the network function producer for the communication device.

The apparatus may comprise means for determining if the events are still to be provided to the network function consumer based on the subscription information defining the scope of the subscription, when there is a change associated with the communications device.

The change associated with the communications device comprises one or more of: a change in location of the communications device; a change of public land mobile network; a network slice change; and/or a change of standalone non-public network.

The determining means may be for determining if the events are to be provided to the network function consumer based on the subscription information defining the scope of the subscription, when there is a change associated with the communications device.

The apparatus may comprise means for causing a message to be sent to the network function consumer indicating that the subscription has ended, when it is determined based on the subscription information defining the scope of the subscription that the events are not be provided to the network function consumer when there is a change associated with the communications device.

The determining means may be for determining if the subscription of the network function consumer is to be transferred to a target network function producer, wherein the determining is based on the subscription information defining the scope of the subscription.

The determining if the subscription of the network function consumer is to be transferred to a target network function producer may be based on a public land mobile network identity, and/or a standalone non-public network and/or region and/or area of the target network function.

The determining if the subscription of the network function consumer is to be transferred to a target network function producer may be based on the public land mobile network identity and/or a standalone non-public network and/or region and/or area of the target network function producer falls within the scope of the subscription.

The determining if the subscription of the network function consumer is to be transferred to a target network function producer may be performed in response to the communication device moving from the network function producer to the target network function producer.

The apparatus may comprise means for causing a message to be sent to the network function consumer indicating that the subscription has ended, when it is determined that the subscription is not to be transferred to the target network function producer.

The determining means may be for cancelling the subscription when it is determined that the that the subscription is not to continue with the further network function producer.

The apparatus may comprise means for causing the subscription to be transferred to the target network function producer, when it is determined that the subscription is to be transferred to the target network function producer, and for causing the subscription information defining the scope of the subscription to be provided to the target network function producer.

The receiving means may be for receiving at the network function, information indicating that that subscription for the network function consumer to receive events is changing from receiving events from the network function producer to receiving events from a further network function producer and the determining means may be for determining based on the subscription information defining the scope for the subscription if the subscription is to continue with the further network function producer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The apparatus may be provided in a network function or be a network function. The network function may be other than the network function producer and network function consumer.

According to a tenth aspect, there is provided an apparatus comprising: means for receiving at a network function, information indicating that a subscription for a network function consumer to receive events is changing from receiving events from a first network function producer to receiving events from a second network function producer, the events being associated with a communications device; and means for determining based on subscription information defining a scope for the subscription if the subscription is to continue with the second network function producer.

The apparatus may be provided in a network function or be a network function. The network function may be other than the network function producer and network function consumer.

It should be appreciated that one or more of the features of the ninth aspect may be used in combination with this tenth aspect.

According to an eleventh aspect, there is provided an apparatus comprising: receiving circuitry configured to receive at a network function, a subscription and subscription information defining a scope for the subscription, the subscription being for a network function consumer to receive events from a network function producer, the events being associated with a communications device; and determining circuitry configured to determine, based on the subscription information, that the subscription to the network function producer is to be set up.

The apparatus may comprise circuitry configured to determine if the events are to be provided to the network function consumer based on the subscription information defining the scope of the subscription.

The determining if the events are to be provided to the network function consumer may be based on if the subscription scope is matched by the network function producer for the communication device.

The apparatus may comprise circuitry configured to determine if the events are still to be provided to the network function consumer based on the subscription information defining the scope of the subscription, when there is a change associated with the communications device.

The change associated with the communications device comprises one or more of: a change in location of the communications device; a change of public land mobile network; a network slice change; and/or a change of standalone non-public network.

The determining circuitry may be configured to determine if the events are to be provided to the network function consumer based on the subscription information defining the scope of the subscription, when there is a change associated with the communications device.

The apparatus may comprise circuitry configured to cause a message to be sent to the network function consumer indicating that the subscription has ended, when it is determined based on the subscription information defining the scope of the subscription that the events are not be provided to the network function consumer when there is a change associated with the communications device.

The determining circuitry may be configured to determine if the subscription of the network function consumer is to be transferred to a target network function producer, wherein the determining is based on the subscription information defining the scope of the subscription.

The determining if the subscription of the network function consumer is to be transferred to a target network function producer may be based on a public land mobile network identity, and/or a standalone non-public network and/or region and/or area of the target network function.

The determining if the subscription of the network function consumer is to be transferred to a target network function producer may be based on the public land mobile network identity and/or region and/or area of the target network function producer falls within the scope of the subscription.

The determining if the subscription of the network function consumer is to be transferred to a target network function producer may be performed in response to the communication device moving from the network function producer to the target network function producer.

The apparatus may comprise circuitry configured to cause a message to be sent to the network function consumer indicating that the subscription has ended, when it is determined that the subscription is not to be transferred to the target network function producer.

The apparatus may comprise circuitry configured to cancel the subscription when it is determined that the that the subscription is not to continue with the further network function producer.

The apparatus may comprise circuitry configured to cause the subscription to be transferred to the target network function producer, when it is determined that the subscription is to be transferred to the target network function producer, and for causing the subscription information defining the scope of the subscription to be provided to the target network function producer.

The receiving circuitry may be configured to receive at the network function, information indicating that that subscription for the network function consumer to receive events is changing from receiving events from the network function producer to receiving events from a further network function producer and the determining circuitry may be configured to determine, based on the subscription information defining the scope for the subscription if the subscription is to continue with the further network function producer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more standalone non-public networks in which the subscribing to events applies; one or more standalone non-public networks in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The apparatus may be provided in a network function or be a network function. The network function may be other than the network function producer and network function consumer.

According to a twelfth aspect, there is provided an apparatus comprising: receiving circuitry configured to receive at a network function, information indicating that a subscription for a network function consumer to receive events is changing from receiving events from a first network function producer to receiving events from a second network function producer, the events being associated with a communications device; and determining circuitry configured to determine based on subscription information defining a scope for the subscription if the subscription is to continue with the second network function producer.

The apparatus may be provided in a network function or be a network function. The network function may be other than the network function producer and network function consumer.

It should be appreciated that one or more of the features of the eleventh aspect may be used in combination with this twelfth aspect.

According to a thirteenth aspect, there is provided an apparatus comprising at least one processor and at least one memory storing instructions that, when executed by the at least one processor cause the apparatus at least to: receive at a network function, a subscription and subscription information defining a scope for the subscription, the subscription being for a network function consumer to receive events from a network function producer, the events being associated with a communications device; and determine, based on the subscription information, that the subscription to the network function producer is to be set up.

The apparatus may be caused to determine if the events are to be provided to the network function consumer based on the subscription information defining the scope of the subscription.

The determining if the events are to be provided to the network function consumer may be based on if the subscription scope is matched by the network function producer for the communication device.

The apparatus may be caused to determine if the events are still to be provided to the network function consumer based on the subscription information defining the scope of the subscription, when there is a change associated with the communications device.

The change associated with the communications device comprises one or more of: a change in location of the communications device; a change of public land mobile network; a network slice change; and/or a change of standalone non-public network.

The apparatus may be caused to determine if the events are to be provided to the network function consumer based on the subscription information defining the scope of the subscription, when there is a change associated with the communications device.

The apparatus may be caused to cause a message to be sent to the network function consumer indicating that the subscription has ended, when it is determined based on the subscription information defining the scope of the subscription that the events are not be provided to the network function consumer when there is a change associated with the communications device.

The apparatus may be caused to determine if the subscription of the network function consumer is to be transferred to a target network function producer, wherein the determining is based on the subscription information defining the scope of the subscription.

The determining if the subscription of the network function consumer is to be transferred to a target network function producer may be based on a public land mobile network identity, and/or a standalone non-public network and/or region and/or area of the target network function.

The determining if the subscription of the network function consumer is to be transferred to a target network function producer may be based on the public land mobile network identity and/or region and/or area of the target network function producer falls within the scope of the subscription.

The determining if the subscription of the network function consumer is to be transferred to a target network function producer may be performed in response to the communication device moving from the network function producer to the target network function producer.

The apparatus may be caused to cause a message to be sent to the network function consumer indicating that the subscription has ended, when it is determined that the subscription is not to be transferred to the target network function producer.

The apparatus may be caused to cancel the subscription when it is determined that the that the subscription is not to continue with the further network function producer.

The apparatus may be caused to cause the subscription to be transferred to the target network function producer, when it is determined that the subscription is to be transferred to the target network function producer, and for causing the subscription information defining the scope of the subscription to be provided to the target network function producer.

The apparatus may be caused to receive at the network function, information indicating that that subscription for the network function consumer to receive events is changing from receiving events from the network function producer to receiving events from a further network function producer and the determining means may be for determining based on the subscription information defining the scope for the subscription if the subscription is to continue with the further network function producer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more standalone non-public networks in which the subscribing to events applies; one or more standalone non-public networks in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The apparatus may be provided in a network function or be a network function. The network function may be other than the network function producer and network function consumer.

According to a fourteenth aspect, there is an apparatus comprising at least one processor and at least one memory storing instructions that, when executed by the at least one processor cause the apparatus at least to: receive at a network function, information indicating that a subscription for a network function consumer to receive events is changing from receiving events from a first network function producer to receiving events from a second network function producer, the events being associated with a communications device; and determine based on subscription information defining a scope for the subscription if the subscription is to continue with the second network function producer.

The apparatus may be provided in a network function or be a network function. The network function may be other than the network function producer and network function consumer.

It should be appreciated that one or more of the features of the thirteenth aspect may be used in combination with this fourteenth aspect.

According to a fifteenth aspect, there is provided a method comprising: receiving at a network function, a subscription and subscription information defining a scope for the subscription, the subscription being for a network function consumer to receive events from a network function producer, the events being associated with a communications device; and determining, based on the subscription information, that the subscription to the network function producer is to be set up.

The method may comprise determining if the events are to be provided to the network function consumer based on the subscription information defining the scope of the subscription.

The determining if the events are to be provided to the network function consumer may be based on if the subscription scope is matched by the network function producer for the communication device.

The method may comprise determining if the events are still to be provided to the network function consumer based on the subscription information defining the scope of the subscription, when there is a change associated with the communications device.

The change associated with the communications device comprises one or more of: a change in location of the communications device; a change of public land mobile network; a network slice change; and/or a change of standalone non-public network.

The method may comprise determining if the events are to be provided to the network function consumer based on the subscription information defining the scope of the subscription, when there is a change associated with the communications device.

The method may comprise causing a message to be sent to the network function consumer indicating that the subscription has ended, when it is determined based on the subscription information defining the scope of the subscription that the events are not be provided to the network function consumer when there is a change associated with the communications device.

The method may comprise determining if the subscription of the network function consumer is to be transferred to a target network function producer, wherein the determining is based on the subscription information defining the scope of the subscription.

The determining if the subscription of the network function consumer is to be transferred to a target network function producer may be based on a public land mobile network identity, and/or a standalone non-public network and/or region and/or area of the target network function.

The determining if the subscription of the network function consumer is to be transferred to a target network function producer may be based on the public land mobile network identity and/or region and/or area of the target network function producer falls within the scope of the subscription.

The determining if the subscription of the network function consumer is to be transferred to a target network function producer may be performed in response to the communication device moving from the network function producer to the target network function producer.

The method may comprise causing a message to be sent to the network function consumer indicating that the subscription has ended, when it is determined that the subscription is not to be transferred to the target network function producer.

The method may comprise cancelling the subscription when it is determined that the that the subscription is not to continue with the further network function producer.

The method may comprise causing the subscription to be transferred to the target network function producer, when it is determined that the subscription is to be transferred to the target network function producer, and for causing the subscription information defining the scope of the subscription to be provided to the target network function producer.

The method may comprise receiving at the network function, information indicating that that subscription for the network function consumer to receive events is changing from receiving events from the network function producer to receiving events from a further network function producer and the determining means may be for determining based on the subscription information defining the scope for the subscription if the subscription is to continue with the further network function producer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more standalone non-public networks in which the subscribing to events applies; one or more standalone non-public networks in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The method may be provided by an apparatus. The apparatus may be provided in a network function or be a network function. The network function may be other than the network function producer and network function consumer.

According to a sixteenth aspect, there is provided a method comprising: receiving at a network function, information indicating that a subscription for a network function consumer to receive events is changing from receiving events from a first network function producer to receiving events from a second network function producer, the events being associated with a communications device; and determining based on subscription information defining a scope for the subscription if the subscription is to continue with the second network function producer.

The method may be provided by an apparatus. The apparatus may be provided in a network function or be a network function. The network function may be other than the network function producer and network function consumer.

It should be appreciated that one or more of the features of the fifteenth aspect may be used in combination with this sixteenth aspect.

According to a seventeenth aspect, there is provided an apparatus comprising:
means for subscribing to receive events, associated with a communications device, from a network function producer; and means for providing subscription information defining a scope for the providing of events.

The apparatus may comprise means for causing a message to be sent to create a subscription to receive the events, said message comprising the subscription information defining the scope of the subscription.

The apparatus may comprise means for receiving a message indicating that the subscription has ended, when it is determined based on the subscription information defining the scope of the subscription that the events are not be provided when there is a change associated with the communications device.

The apparatus may comprise means for receiving a message indicating that the subscription has ended, when it is determined that the subscription is not to be transferred to a target network function producer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more standalone non-public networks in which the subscribing to events applies; one or more standalone non-public networks in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The apparatus may be provided in a network function consumer or be a network function consumer.

According to an eighteenth aspect, there is provided an apparatus comprising:
circuitry configured to subscribe to receive events, associated with a communications device, from a network function producer; and circuitry configured to provide subscription information defining a scope for the providing of events.

The apparatus may comprise circuitry configured to cause a message to be sent to create a subscription to receive the events, said message comprising the subscription information defining the scope of the subscription.

The apparatus may comprise circuitry configured to receive a message indicating that the subscription has ended, when it is determined based on the subscription information defining the scope of the subscription that the events are not be provided when there is a change associated with the communications device.

The apparatus may comprise circuitry configured to receive a message indicating that the subscription has ended, when it is determined that the subscription is not to be transferred to a target network function producer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more standalone non-public networks in which the subscribing to events applies; one or more standalone non-public networks in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The apparatus may be provided in a network function consumer or be a network function consumer.

According to a nineteenth aspect, there is provided an apparatus comprising at least one processor and at least one memory storing instructions that, when executed by the at least one processor cause the apparatus at least to: subscribe to receive events, associated with a communications device, from a network function producer; and provide subscription information defining a scope for the providing of events.

The apparatus may be caused to cause a message to be sent to create a subscription to receive the events, said message comprising the subscription information defining the scope of the subscription.

The apparatus may be caused to receive a message indicating that the subscription has ended, when it is determined based on the subscription information defining the scope of the subscription that the events are not be provided when there is a change associated with the communications device.

The apparatus may be caused to receive a message indicating that the subscription has ended, when it is determined that the subscription is not to be transferred to a target network function producer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more standalone non-public networks in which the subscribing to events applies; one or more standalone non-public networks in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The apparatus may be provided in a network function consumer or be a network function consumer.

According to a twentieth aspect, there is provided method comprising: subscribing to receive events, associated with a communications device, from a network function producer; and providing subscription information defining a scope for the providing of events.

The method may comprise causing a message to be sent to create a subscription to receive the events, said message comprising the subscription information defining the scope of the subscription.

The method may comprise receiving a message indicating that the subscription has ended, when it is determined based on the subscription information defining the scope of the subscription that the events are not be provided when there is a change associated with the communications device.

The method may comprise receiving a message indicating that the subscription has ended, when it is determined that the subscription is not to be transferred to a target network function producer.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following: information indicating whether the subscription applies when the communications device is roaming and/or not roaming; information indicating that the subscription is limited to an intra public land mobile network change of network function producer; information indicating that the subscription applies to inter-standalone non-public network change of network function producer; information indicating that the subscription is limited to intra-standalone non-public network change of network function producer; and/or information indicating that the subscription applies to inter public land mobile network change of network function producer.

The subscription information, defining the scope of the subscription, may define one or more of the following: one or more conditions indicating if the subscribing to events continues to apply when the communications device roams from one of a home public land mobile network and a visiting public land mobile network to the other of the home public land mobile network and the visiting public land mobile network; one or more public land mobile networks in which the subscribing to events applies; one or more public land mobile networks in which the subscribing to events does not apply; one or more standalone non-public networks in which the subscribing to events applies; one or more standalone non-public networks in which the subscribing to events does not apply; one or more network slices in which the subscribing to events applies; one or more network slices in which the subscribing to events does not apply; one or more areas in which the subscribing to events applies; one or more areas in which the subscribing to events does not apply; one or more tracking area identities in which the subscribing to events applies; and/or one or more tracking area identities in which the subscribing to events does not apply.

The network function producer may comprise a network mobility management function or a network data function.

The network function producer may be an access and mobility management function.

The network function producer may comprise a network data function.

The network data function may be a network data analytics function or a data collection coordination function.

The method may be provided by an apparatus. The apparatus may be provided in a network function consumer or be a network function consumer.

According to a further aspect, there is provided a computer program comprising instructions, which when executed by the apparatus, cause the apparatus to perform any of the methods set out previously.

According to a further aspect, there is provided a computer program comprising instructions, which when executed cause any of the methods set out previously to be performed.

According to an aspect there is provided a computer program comprising computer executable code which when cause any of the methods set out previously to be performed.

According to an aspect, there is provided a computer readable medium comprising program instructions stored thereon for performing at least one of the above methods.

According to an aspect, there is provided a non-transitory computer readable medium comprising program instructions which when executed by the apparatus, cause the apparatus to perform any of the methods set out previously.

According to an aspect, there is provided a non-transitory computer readable medium comprising program instructions which when executed cause any of the methods set out previously to be performed.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### List of Abbreviations

3GPP Third generation partnership project
AF Application Function
AMF Access and Mobility Management Function
AUSF Authentication Server Function
CIoT Cellular Internet of thing
DN Data network
gNB gNodeB
HPLMN Home PLMN
HTTP Hypertext Transfer Protocol
IE Information Element
IoT Internet of Things
JSON Java Script Object Notation
MS Mobile Station
MTC Machine Type Communication
NEF Network Exposure Function
NF Network Function
NC NF service consumer
NFp NF service producer
NWDAF Network data analytics function
PLMN Public Land Mobile Network
RAM Random Access Memory
(R)AN (Radio) Access Network
ROM Read Only Memory
SMF Session Management Function
TS Technical Specification
UPF User plane function
UDM Unified Data Management
UE User Equipment
VPLMN Visiting PLMN
3GPP 3^{rd} Generation Partnership Project
5G 5^{th} Generation
5GC 5G Core network
5GS 5G System

### BRIEF DESCRIPTION OF THE FIGURES

Some example embodiments will now be described, by way of example only, with reference to the accompanying Figures in which:

FIG. 1 shows a schematic representation of a 5G system;

FIG. 2 shows a schematic representation of an apparatus;

FIG. 3 shows a schematic representation of a user equipment;

FIG. 4 shows a schematic representation of a signal flow to set up a subscription;

FIG. 5 shows a schematic representation of a signal flow of some embodiments where this a change in network function producer;

FIG. 6 shows a schematic representation of a signal flow of some embodiments where an intermediate node is used to create a subscription;

FIG. 7 shows a first method of some embodiments;

FIG. 8 shows a second method of some embodiments;

FIG. 9 shows a third method of some embodiments;

FIG. 10 shows a fourth method of some embodiments;

FIG. 11 shows a fifth method of some embodiments; and

FIG. 12 shows a schematic representation of a non-volatile memory medium storing instructions which when executed by a processor allow a processor to perform one or more of the steps of any of the methods of FIGS. 7 to 11.

### DETAILED DESCRIPTION OF THE FIGURES

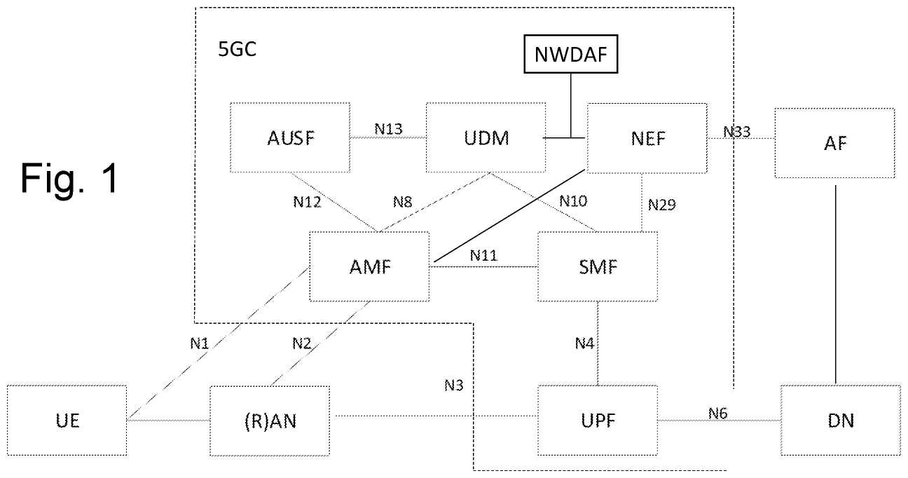

In the following certain embodiments are explained with reference to mobile communication devices capable of communication via a wireless cellular system and mobile communication systems serving such mobile communication devices. Before explaining in detail, the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a user equipment (UE), a (radio) access network ((R)AN), a 5G core network (5GC), one or more application functions (AF) and one or more data networks (DN).

The 5G (R)AN may comprise one or more gNodeB (gNB) distributed unit functions connected to one or more gNodeB (gNB) centralized unit functions.

The 5GC may comprise an access and mobility management function (AMF), a session management function (SMF), an authentication server function (AUSF), a user data management (UDM), a user plane function (UPF) a network data analytics function (NWDAF) and/or a network exposure function (NEF).

In some embodiments, one or more network functions may be responsible for providing network analytics information upon request from one or more other network functions or apparatus within the network. Network functions can subscribe to other network functions to receive information therefrom. Accordingly, a network function may be configured to receive and store network information from one or more network functions or apparatus within the network. The data collection by a network may be performed based on at least one subscription to the events provided by at least one other network function.

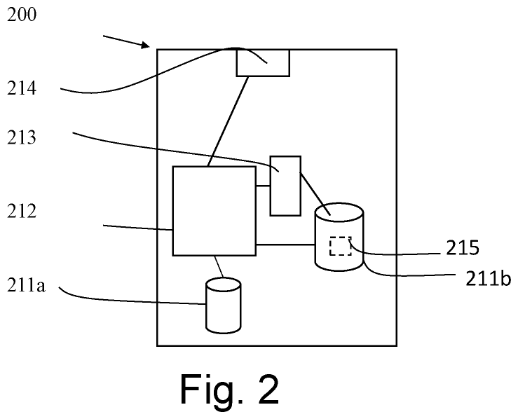

FIG. 2 illustrates an example of an apparatus 200. The apparatus may be provided in a network function. The network function may an intermediate network function, a network function consumer or a network function producer. The apparatus may have at least one processor and at least one memory storing instructions that, when executed by the at least one processor cause one or more functions to be performed. In this example, the apparatus may comprise at least one random access memory (RAM) 211a, and/or at least one read only memory (ROM) 211b, and/or at least one processor 212, 213 and/or an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The apparatus may be provided in one or more network functions.

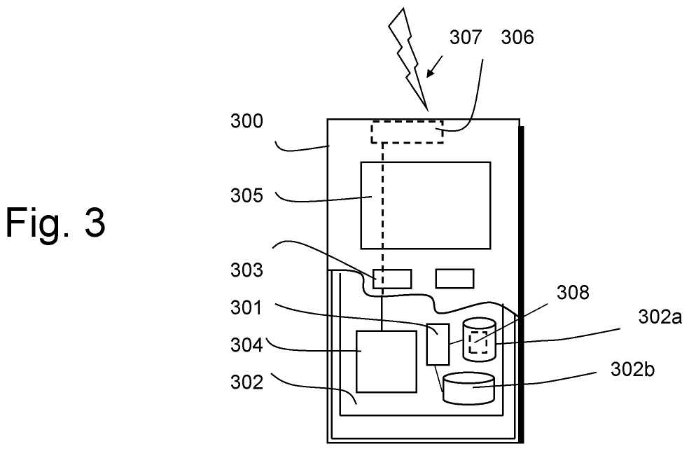

FIG. 3 illustrates an example of a communications device 300, such as the UE illustrated on FIG. 1. The communications device 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The communications device 300 may provide, for example, communication of data for carrying communications. The communications may be one or more of voice, electronic mail (email), text message, multimedia, data, machine data and so on.

The communications device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The communications device 300 may be provided with at least one processor 301, and/or at least one memory ROM 302a, and/or at least one RAM 302b and/or other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304.

The communications device may optionally have a user interface such as keypad 305, touch sensitive screen or pad, combinations thereof or the like. Optionally one or more of a display, a speaker and a microphone may be provided depending on the type of the communications device.

In the following examples, reference is made to a UE as an example of a communications device. It should be noted that this is by way of example only and any other suitable communications device may be used in embodiments.

Current 3GPP specifications and proposals enable a service consumer to subscribe to notifications for events from a service producer. These subscriptions may be mediated by an intermediary network node, such as a UDM or a Data Collection and Coordination Function (DCCF).

An NFc (NF service consumer) may subscribe to an NFp (NF service producer) to be notified about certain events detected by the NFp. The NFc does so by creating an event subscription to the NFp. When the subscription is created, the NFp sends event notifications to the subscribed NFc when the subscribed events occur.

An intermediate network function may mediate between a network function service consumer and a network function service producer. Alternatively, there may be direct subscriptions from an NF service consumer to an NF service producer (i.e. subscriptions not mediated by an intermediate network function).

In some 3GPP specifications, during an inter-AMF mobility of a UE, the subscriptions that were created in the source AMF are moved with the UE context to the target AMF, and the target AMF continues reporting the subscribed events to the NFc.

Inter-PLMN AMF to AMF mobility of a UE is possible. The UE may be in an idle mode or a connected mode. In other words, the UE may be handed over from one AMF to another in different PLMN. This may be due to the mobility of the UE.

NFc created subscription objects at the AMF are stored in the UE context. The NFc may be any suitable NFC such as a UDM, a NEF, a NWDAF or the like. The subscription objects are transferred from AMF1 (e.g., PLMN1 or Region 1 of a HPLMN) to AMF2 (e.g., PLMN2 or Region 2 of HPLMN).

The 3GPP standard TS 29.518 defines the data type of UE context which includes an event subscription list. The following is taken from Table 6.1.6.2.25-1: Definition of type UeContext from TS 29.518.

| Attribute | | | | |
|---|---|---|---|---|
| name | Data type | P | Cardinality | Description |
| Event | array(ExtAmf | C | 1 . . . N | This IE shall be present if |
| SubscriptionList | Event | | | available and if it is not case b) |
| | Subscription) | | | specified in clause 5.2.2.2.1.1 |
| | | | | step 2a. When present, it shall |
| | | | | indicate the event |
| | | | | subscription(s) targeting the UE |
| | | | | or the group the UE is part of. |
| | | | | If the source AMF supports |
| | | | | binding procedures and if it |
| | | | | received binding indications for |
| | | | | event notifications (i.e. with |
| | | | | “callback” scope) or for |
| | | | | subscription change event |
| | | | | notifications (i.e. with |
| | | | | “subscription-events” scope) for |
| | | | | certain subscriptions, these |
| | | | | binding indications should also |
| | | | | be included. |
| | | | | If the source AMF knows the |
| | | | | NF type of the NF that created |
| | | | | the subscription, this |
| | | | | information should also be |
| | | | | indicated. |

In 3GPP standard TS 29.518, where there is a UE Context transfer from a source AMF to a target, if there is an event subscription at the source AMF, the event subscription is always transferred to the target AMF as a part of context transfer.

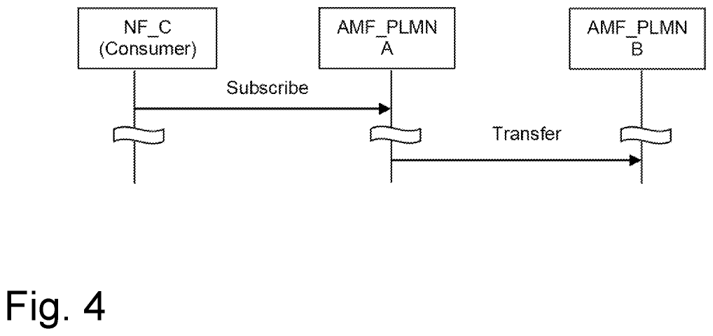

Reference is made to FIG. 4. In this example, the NFc (e.g., an AF via a NEF, a NWDAF, or a UDM) creates a subscription at AMF-A (for example for UE location reporting). If the user moves from AMF-A/PLMN-A to AMF-B/PLMN-B, currently there is no option available for the NF consumer to inform the AMF-A that subscription should not be transferred to AMF-B/PLMN-B.

Due to this, with current proposals, the AMF-A always transfers the subscription to AMF-B irrespective of whether the NFc is willing to or needs to receive the notifications from the AMF-B that could be in PLMN-B.

One example, where an NFc is would not want to receive notifications from an NFp after the UE has moved to a different PLMN is as follows: an NWDAF in an HPLMN wants to collect data for a UE from the HPLMN but the NWDAF in 3GPP Rel-17 may not support roaming or may not collect data from VPLMN. When the NWDAF(PLMN1) subscribes to AMF1 (PLMN1) to get continued UE location reporting, if UE moves to AMF2/PLMN2, then with existing proposals, the NWDAF will start receiving notifications from VPLMN.

Therefore, current proposals do not determine whether subscriptions created at a source NF (e.g., source AMF) should be transferred to a target NF (e.g. target AMF) upon inter-NF (e.g. inter-AMF) context transfer (e.g. inter-AMF mobility of a UE). This can for example result in a target NF sending notifications to the NFc where that NFc is not interested in that inter PLMN data.

Another scenario with the existing proposals is as follows. A same NFp (e.g., AMF) may serve multiple PLMNs (e.g., when using network sharing) or regions/areas. In such a case, the NFp may also continue sending notifications to the NFc when the NFp starts serving the UE via a different PLMN or region/area (e.g., when the UE would re-register to the AMF for a different PLMN). Thus, issues may also arise for intra-NF (e.g., intra-AMF) scenarios.

Another scenario with the existing proposals is as follows. An NFc (e.g., NEF) may subscribe to events produced by an NFp via an intermediate NF, e.g. UDM. In such a case, the NFc may not be aware of whether the NFp (e.g., AMF) that is currently serving the UE is located in the same PLMN (e.g., HPLMN) as the NFc or in a different PLMN. This may result in the intermediate NF subscribing (on behalf of the NFc) to an NFp (e.g. AMF) currently serving the UE that is in a different PLMN (or Region/Area) than the PLMN of NFc. This may cause the NFc to start receiving notifications e.g., from a VPLMN when the NFc only wants to receive notifications from the HPLMN. Thus, current proposals may lack a mechanism to enable the intermediate NF to determine whether it should subscribe (on behalf of NFc) to an NFp based on the PLMN identity (or Region/Area) served by the NFp.

Other examples in the current proposals are NWDAF to NWDAF handover and DCCF to DCCF handover. Similar issues to those set out above may also arise in these handovers.

Some embodiments may provide subscription scope. The NFc may signal the subscription scope to the NFp or to the intermediate NF during the creation of the subscription. This subscription scope may be an extension to the subscription information, such as previously described, or the subscriptions scope may be separately provided.

The subscription information, defining the scope of the subscription, may define one or more conditions indicating if the subscribing to events by the network function consumer continues to apply when the network function producer is changed.

The subscription information, defining the scope of the subscription, may define one or more conditions indicating if the subscribing to events continues to apply when a location of the communications device changes.

The subscription information, defining the scope of the subscription, may define one or more conditions indicating if the subscribing to events continues to apply when the communications device changes from one public land mobile network or standalone non-public network to another public land mobile network or standalone non-public network.

The subscription information, defining the scope of the subscription, may define one or more of the following:
information indicating whether the subscription applies when the communications device is roaming and/or not roaming;
information indicating that the subscription is limited to an intra public land mobile network change of network function producer;
information indicating that the subscription applies to inter-standalone non-public network change of network function producer;
information indicating that the subscription is limited to intra-standalone non-public network change of network function producer. and/or
information indicating that the subscription applies to inter public land mobile network change of network function producer.

The subscription information, defining the scope of the subscription, may define one or more of the following:
one or more conditions indicating if the subscribing to events continues to apply when the communications device roams from one of a home public land mobile network and a visiting public land mobile network to the other of the home public land mobile network and the visiting public land mobile network;
one or more public land mobile networks in which the subscribing to events applies;
one or more public land mobile networks in which the subscribing to events does not apply;
one or more standalone non-public network in which the subscribing to events applies;
one or more standalone non-public network in which the subscribing to events does not apply;
one or more network slices in which the subscribing to events applies; one or more network slices in which the subscribing to events does not apply;
one or more areas in which the subscribing to events applies;
one or more areas in which the subscribing to events does not apply;
one or more tracking area identities in which the subscribing to events applies; and/or
one or more tracking area identities in which the subscribing to events does not apply.

By way of example, the subscription scope may comprise any one or more of the following:
An indication of whether the subscription applies when the UE is roaming and/or not roaming. For example, this may be used to indicate that the subscription scope is limited to when the UE is not roaming, i.e., is in its HPLMN;
An indication of whether the subscription applies to intra-PLMN and/or inter-PLMN mobility. For example, this may be used to indicate that the subscription scope is limited to when there is intra-PLMN change of NFp;
Allowed PLMN ID list and/or Not Allowed PLMN ID list, i.e., list of PLMNs in which the subscription applies (or alternatively, does not apply);
A list of regions/areas in which the subscription applies (and/or does not apply, e.g., for large PLMNs that are operated by different operator organizations in different regions). This may be defined by area lists. The area lists may have Allowed TAIs and/or not allowed TAIs; and/or
Allowed network slice list and/or not allowed network slice list.

In some embodiments, the NFp (e.g. source AMF) determines, based on the new subscription scope information, whether it should transfer the subscription to a target NFp (e.g. target AMF) during a change of NFp (e.g., inter-AMF mobility), and whether it should continue to send notifications even in absence of a change of NFp when the NF would start serving the UE for a different PLMN (or Region/Area).

In some embodiments, the intermediate NF (e.g., UDM) determines, based on the new subscription scope information, whether it should subscribe (on behalf of NFc) to the NFp (e.g. AMF) currently serving the UE, based on the PLMN ID (or Region/Area) of the NFp.

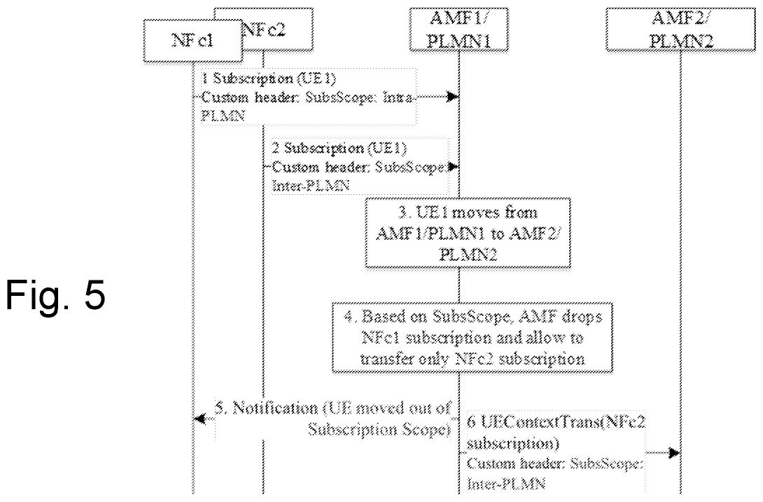

Reference is made to FIG. 5 which shows an example where there is a change of AMF from a first AMF1 to a second AMF2. The first AMF1 is associated with a first PLMN1 and the second AMF2 is associated with a second PLMN2.

As referenced 1, NFc1 creates a subscription at the AMF1/PLMN1. NFc1 provides a subscription scope to the first AMF1.

As referenced 2, NFc2 creates a subscription at the AMF1/PLMN1. NFcr2 provides a subscription scope to the first AMF1.

The subscription scope can be provided by the NFc entity to the AMF in any suitable way.

For example the subscription scope information may be signaled part of a HTTP custom header. Where the embodiment is provided in a 5G system, this header may be as defined in TS 29.500.

The subscription scope information may be signaled r by an attribute within a HTTP message payload. In the latter case, the attribute may be encoded as a JSON attribute.

The subscription scope may contain any of the information discussed previously.

The source AMF, AMF1 will stores the subscription scope for each request, i.e., each subscription.

As referenced 3, the UE moves from AMF1/PLMN1 to AMF2/PLMN2.

Subscription events may be required to be transferred from AMF1 to AMF2. Accordingly, as referenced 4, the first AMF1 shall determine, per subscription, whether to transfer the subscription to the target AMF2 based on for example, the subscription scope and PLMN ID (or Region/Area) of the target AMF. The first AMF may check if the subscription scope matches or is appropriate for the second AMF2. The AMF may check one, more or all the parameters of the subscription scope when making a determination that the subscription is to be transferred.

For example, if the subscription scope indicates that the subscription is applicable to/allowed for the target PLMN, then as referenced 6 in FIG. 5, the first AMF1 transfers the subscription to the target AMF2. Where the AMF1 transfers the subscription to AMF-2, the first AMF1 may provide subscription scope per subscription so that AMF2 can process the subscription appropriately, for example, during a later mobility from AMF2 to another AMF.

However, if the subscription scope restricts the applicability of the subscription when the UE is not roaming, then the first AMF1 will not to AMF2 (VPLMN) (see further steps).

For example, if the subscription scope indicates that the subscription is not applicable to/allowed for the target PLMN, then as referenced 5 in FIG. 5, the first AMF1 does not transfers the subscription to the target AMF2. The first AMF1 may sends an event notification to one or more NFc(s) indicating that the subscription is terminated because the UE has moved to an NFp that is out of/does not match the subscription scope. This may be because the target AMF has for example a different PLMN and/or different network slices to those indicated in the subscription scope.

In the example shown in FIG. 5, the NFc1 subscription scope is “intra PLMN” and NFc2 subscription scope is “inter PLMN”. In this example, the NFc2 subscription transferred to the target AMF-2 which is in a different PLMN and the first AMF1 sends a notification to NFc1 that UE has moved out of scoping area.

In the previous example, the subscription context transfer has been described where the source NFc and target NFc are AMFs. It should be appreciated that embodiments may be used with any other suitable source and target NFc. For example the NFc may be a mobility supporting network function. In other embodiments, the NFc may be a NWDAF and/or a DCCF. The source and target NFc may be the same type of entity or different types of entity.

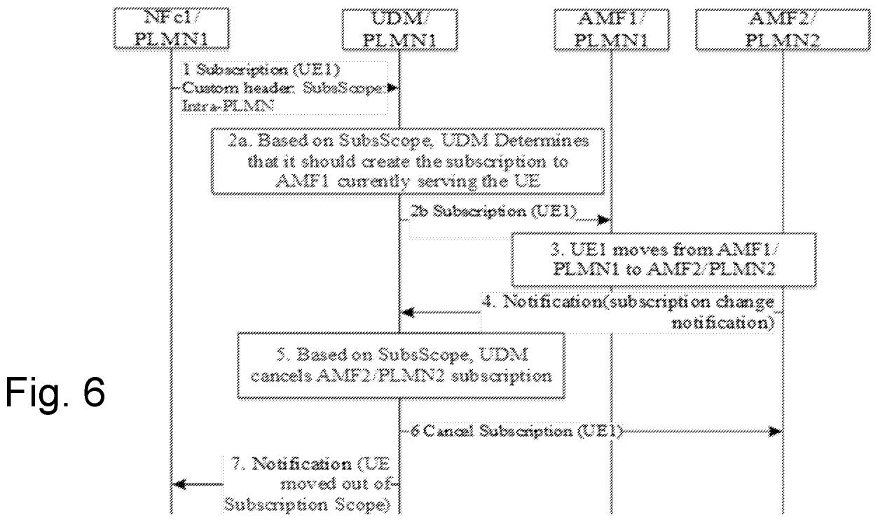

Reference is made to FIG. 6 which shows an example where a subscription is created via an intermediate NF

For events created via UDM (e.g., by NEF), the same principles apply.

As referenced 1 in FIG. 6, the NFc1 provides the subscription scope to the UDM.

As referenced 2a in FIG. 6, the UDM uses the subscription scope to determine whether the NFp (e.g., AMF) currently serving the UE matches the subscription scope, and if so, the UDM creates a subscription to the NFp on behalf of NFc. Otherwise, UDM does not create a subscription. However, the UDM may create the subscription later if the UE moves back to an AMF which satisfies the subscription scope. This may occur, for example, when the UE moves back to an AMF of its HPLMN (i.e., to an NFp that would match the subscription scope).

When creating a subscription in the NFp on behalf of a NFc, the UDM may provide the subscription scope to AMF. The UDM may consume this subscription scope and inform the AMF about the subscription scope.

Alternatively, when creating a subscription in the NFp on behalf of a NFc, the UDM does not provide the subscription scope to AMF. The UDM may consume the subscription scope without further informing the AMF about the subscription scope.

As referenced 2b in FIG. 6, the first AMF1 is informed of the subscription and optionally about the subscription scope.

As referenced 3 in FIG. 6, when the UE moves from AMF1/PLMN1 to AMF2/PLMN2, if the AMF1 did not receive the subscription scope, or if it does not support these enhancements (e.g., legacy AMF implementation), the AMF1 transfers the subscriptions to AMF2.

As referenced 4 in FIG. 6, the UDM receives a subscription change notification. This may be in line with current 3GPP specifications.

As referenced 5 in FIG. 6, the UDM can determine either to cancel the subscription if the new AMF does not match the subscription scope or continue the subscription.

As referenced 6 in FIG. 6, the UDM will inform the second AMF2 is informed of the cancellation of the subscription.

As referenced 7 in FIG. 6, the UDM will inform the NFc is informed that the UE has moved out of the subscription scope.

In some embodiments, if the UDM does not forward the subscription scope to AMF1, or if AMF1 does not support these enhancements, for a small amount of time (because AMF2 is not aware of the subscription scope), the second AMF2 can send data to the NFc (between step 4 and Step 6).

In some embodiment in which a subscription is created directly by an NFc (not via UDM), the NFc can cancel the subscription on its own when the UE mobility results in the NFp being outside of the subscription scope.

Some embodiments may have the advantage that unnecessary subscription transfers are avoided. This may for example be the case where there is a transfer from one PLMN to another PLMN.

Some embodiments may ensure that a target NFc only receives event notifications that are of interest for that NFc

In one modification, alternatively or additionally, the source NFc may transfer the subscription and subscription scope to the target NFc. The target NFc will decide as to which subscriptions still apply based on the subscription scope.

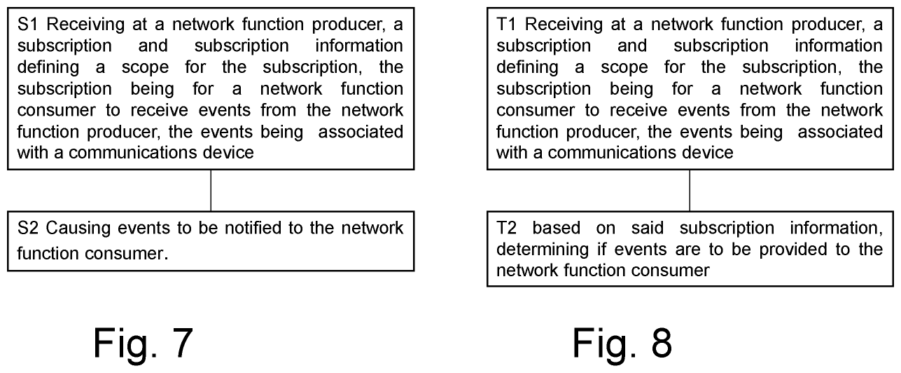

Reference is made to FIG. 7 which shows a first method of some embodiments.

This method may be performed by an apparatus. The apparatus may be in or be a network function producer.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 2.

The method may be provided by computer program code or computer executable instructions.

The method may comprise as referenced S1, receiving at a network function producer, a subscription and subscription information defining a scope for the subscription, the subscription being for a network function consumer to receive events from the network function producer, the events being associated with a communications device.

The method may comprise as referenced S2, causing events to be notified to the network function consumer.

Reference is made to FIG. 8 which shows a second method of some embodiments.

This method may be performed by an apparatus. The apparatus may be in or be a network function producer.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 2.

The method may be provided by computer program code or computer executable instructions.

The method may comprise as referenced T1, receiving at a network function producer, a subscription and subscription information defining a scope for the subscription, the subscription being for a network function consumer to receive events from the network function producer, the events being associated with a communications device.

The method may comprise as referenced T2, based on said subscription information, determining if events are to be provided to the network function consumer.

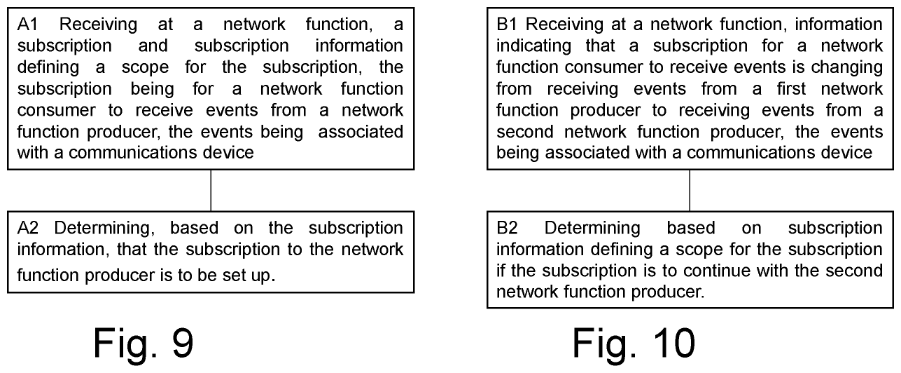

Reference is made to FIG. 9 which shows a third method of some embodiments.

This method may be performed by an apparatus. The apparatus may be in or be a network function. This may be an intermediate network function.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 2.

The method may be provided by computer program code or computer executable instructions.

The method may comprise as referenced A1, receiving at a network function, a subscription and subscription information defining a scope for the subscription, the subscription being for a network function consumer to receive events from a network function producer, the events being associated with a communications device.

The method may comprise as referenced A2, determining, based on the subscription information, that the subscription to the network function producer is to be set up.

Reference is made to FIG. 10 which shows a fourth method of some embodiments.

This method may be performed by an apparatus. The apparatus may be in or be a network function. This may be an intermediate network function.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 2.

The method may be provided by computer program code or computer executable instructions.

The method may comprise as referenced B1 receiving at a network function, information indicating that a subscription for a network function consumer to receive events is changing from receiving events from a first network function producer to receiving events from a second network function producer, the events being associated with a communications device.

The method may comprise as referenced B2, determining based on subscription information defining a scope for the subscription if the subscription is to continue with the second network function producer.

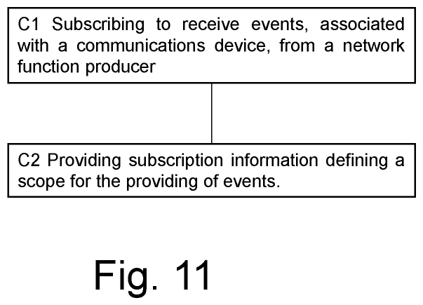

Reference is made to FIG. 11 which shows a fourth method of some embodiments.

This method may be performed by an apparatus. The apparatus may be in or be a network function consumer.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 2.

The method may be provided by computer program code or computer executable instructions.

The method may comprise as referenced C1, subscribing to receive events, associated with a communications device, from a network function producer.

The method may comprise as referenced C2 providing subscription information defining a scope for the providing of events.

It should be appreciated that the methods outlined in FIGS. 7 to 11 may be modified to include any of the previously described features.

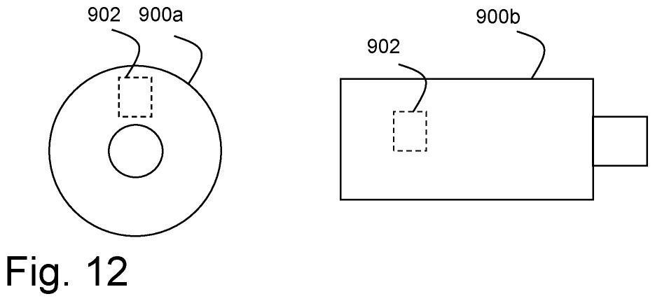

FIG. 12 shows a schematic representation of non-volatile memory media 900a or 900b storing instructions and/or parameters which when executed by a processor allow the processor to perform one or more of the steps of the methods of FIGS. 7 to 11. The non-volatile memory media may be a computer disc (CD), or digital versatile disc (DVD) schematically referenced 900a or a universal serial bus (USB) memory stick schematically referenced 900b. The computer instructions or code may be downloaded and stored in one or more memories. The memory media may store instructions and/or parameters 902 which when executed by a processor allow the processor to perform one or more of the steps of the methods of FIGS. 7 to 11.

Computer program code may be downloaded and stored in one or more memories of the device.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 7 to 11, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Alternatively, or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (I) a combination of analogue and/or digital hardware circuit(s) with software/firmware and
   (ii) any portions of hardware processor(s) with software (including digital signal processor(s)), software, and memory(is) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of the term “means” in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising:
at least one processor; and
at least one memory storing instructions for a network function, wherein the instructions when executed by the at least one processor cause the apparatus to perform:
receiving subscription information defining a scope for a subscription, the subscription being for a network function service consumer to receive events from a network function service producer, the events being associated with a communications device; and
determining, based on the subscription information, that the subscription to the network function service producer is to be set up.

2. The apparatus as claimed in claim 1, wherein the instructions when executed by the at least one processor cause the apparatus to perform:
receiving information indicating that the subscription for the network function service consumer to receive events is changing from receiving events from the network function service producer to receiving events from a further network function producer; and
determining based on the subscription information defining the scope for the subscription that the subscription is to continue with the further network function service producer.

3. The apparatus as claimed in claim 2, wherein the instructions when executed by the at least one processor cause the apparatus to perform:
causing cancelling of the subscription upon determining that the that the subscription is not to continue with the further network function service producer.

4. An apparatus comprising:
at least one processor; and
at least one memory storing instructions for a network function consumer, wherein the instructions when executed by the at least one processor cause the apparatus to perform:
subscribing to receive events, associated with a communications device, from a network function service producer; and
providing subscription information defining a scope for the providing of events.

5. The apparatus as claimed in claim 4, wherein the providing comprises:
sending a message to create a subscription to receive the events, said message comprising the subscription information defining the scope of the subscription.

6. The apparatus as claimed in claim 4, wherein the subscription information defining the scope for the providing of events, defines one or more conditions indicating if the subscribing to events by the network function service consumer continues to apply when the network function producer is changed.

7. The apparatus as claimed in claim 4, wherein the subscription information defining the scope for the providing of events, defines one or more conditions indicating if the subscribing to events continues to apply when a location of the communications device changes.

8. The apparatus as claimed in claim 4, wherein the subscription information defining the scope for the providing of events, defines one or more conditions indicating if the subscribing to events continues to apply when the communications device changes from one public land mobile network or standalone non-public network to another public land mobile network or standalone non-public network.

9. The apparatus as claimed in claim 4, wherein the subscription information defining the scope for the providing of events, defines one or more of the following:
information indicating whether the subscription applies when the communications device is roaming;
information indicating whether the subscription applies when the communications device is not roaming;
information indicating that the subscription is limited to an intra-public land mobile network change of network function service producer;
information indicating that the subscription applies to inter-public land mobile network change of network function service producer;
information indicating that the subscription applies to inter-standalone non-public network change of network function service producer; or
information indicating that the subscription is limited to intra-standalone non-public network change of network function service producer.

10. The apparatus as claimed in claim 4, wherein the subscription information defining the scope for the providing of events, defines one or more of the following:
one or more conditions indicating if the subscribing to events continues to apply when the communications device roams from one of a home public land mobile network and a visiting public land mobile network to the other of the home public land mobile network and the visiting public land mobile network;
one or more public land mobile networks in which the subscribing to events applies;
one or more public land mobile networks in which the subscribing to events does not apply;
one or more standalone non-public networks in which the subscribing to events applies;
one or more standalone non-public networks in which the subscribing to events does not apply;
one or more network slices in which the subscribing to events applies;
one or more network slices in which the subscribing to events does not apply;
one or more areas in which the subscribing to events applies;
one or more areas in which the subscribing to events does not apply;
one or more tracking area identities in which the subscribing to events applies; or
one or more tracking area identities in which the subscribing to events does not apply.

11. The apparatus as claimed in claim 4, wherein the network function producer comprises a network mobility management function or a network data function.

12-14. (canceled)

15. A method comprising:
subscribing to receive events, associated with a communications device, from a network function producer; and
providing subscription information defining a scope for the providing of events.

16. The method as claimed in claim 15, wherein said providing comprises:
sending a message to create a subscription to receive the events, said message comprising the subscription information defining the scope of the subscription.

17. The method as claimed in claim 15, wherein the subscription information defining the scope for the providing of events, defines one or more conditions indicating if the subscribing to events by the network function service consumer continues to apply when the network function producer is changed.

18. The method as claimed in claim 15, wherein the subscription information defining the scope for the providing of events, defines one or more conditions indicating if the subscribing to events continues to apply when a location of the communications device changes.

19. The method as claimed in claim 15, wherein the subscription information defining the scope for the providing of events, defines one or more conditions indicating if the subscribing to events continues to apply when the communications device changes from one public land mobile network or standalone non-public network to another public land mobile network or standalone non-public network.

20. The method as claimed in claim 15, wherein the subscription information defining the scope for the providing of events, defines one or more of the following:
information indicating whether the subscription applies when the communications device is roaming;
information indicating whether the subscription applies when the communications device is not roaming;
information indicating that the subscription is limited to an intra-public land mobile network change of network function service producer;
information indicating that the subscription applies to inter-public land mobile network change of network function service producer;
information indicating that the subscription applies to inter-standalone non-public network change of network function service producer; or
information indicating that the subscription is limited to intra-standalone non-public network change of network function service producer.

21. The method as claimed in claim 15, wherein the subscription information defining the scope for the providing of events, defines one or more of the following:
one or more conditions indicating if the subscribing to events continues to apply when the communications device roams from one of a home public land mobile network and a visiting public land mobile network to the other of the home public land mobile network and the visiting public land mobile network;
one or more public land mobile networks in which the subscribing to events applies;
one or more public land mobile networks in which the subscribing to events does not apply;
one or more standalone non-public networks in which the subscribing to events applies;
one or more standalone non-public networks in which the subscribing to events does not apply;
one or more network slices in which the subscribing to events applies;
one or more network slices in which the subscribing to events does not apply;
one or more areas in which the subscribing to events applies;
one or more areas in which the subscribing to events does not apply;
one or more tracking area identities in which the subscribing to events applies; or
one or more tracking area identities in which the subscribing to events does not apply.

22. The apparatus as claimed in claim 15, wherein the network function producer comprises a network mobility management function or a network data function.

23-24. (canceled)
